(19) United States
(12) Patent Application Publication
(10) Pub. No.: US 2005/0145713 A1
(43) Pub. Date: Jul. 7, 2005

(54) Fuel injector valve

(75) Inventors: Ferdinand Reiter, Margroeningen (DE); Martin Maier, Moeglingen (DE)

Correspondence Address: KENYON & KENYON, ONE BROADWAY, NEW YORK, NY, 10004, US

(73) Assignee: Robert Bosch Gmbh, D-70442 Stuttgart (DE)

(21) Appl. No.: 10/504,480

(22) PCT Filed: Jul. 2, 2003
(86) PCT No.: PCT/DE03/02204

(30) Foreign Application Priority Data
Dec. 19, 2002 (DE) 102 59 799.5

(51) Int. Cl. F02M 47/02; F02M 59/00; F02M 61/00; F02M 39/00; F02M 47/00

(52) U.S. Cl. 239/88; 239/533.2; 239/533.3

(57) ABSTRACT

A fuel injector for the direct injection of fuel into the combustion chamber of an internal combustion engine includes a valve needle situated in a nozzle body, in which the valve needle is actuable by an actuator and acted upon by a restoring spring in such a manner that a valve closure member, which is in operative connection to the valve needle and faces the combustion chamber, is kept in sealing contact on a valve seat surface in the non-actuated state of the actuator. The valve needle is hollow at least in a downstream partial region and is sealed off from the combustion chamber at the front-side.

### FIELD OF THE INVENTION

The present invention relates to a fuel injector.

### BACKGROUND INFORMATION

German patent document no. 195 34 445 refers to an outwardly opening fuel injector which has a conical sealing seat. The valve needle has a central bore leading into a pressure chamber located upstream from the sealing seat. An actuator, which is embodied as a piezoelectric actuator, is braced against a nozzle body on one side and against a pressure shoulder connected to the valve needle by force-locking on the other side. A restoring spring retains the valve needle in a closing position. In response to the actuator being energized, the valve needle, due to the actuator's longitudinal expansion, is opened against the closing force of the restoring spring and fuel is spray-discharged.

A disadvantage of the device of German patent document no. 195 34 445 is that the flow rate in outwardly opening fuel injectors may be subject to great dispersion. Furthermore, manufacturing tolerances in the region of the sealing seat often have an adverse effect on the jet pattern.

### SUMMARY OF THE INVENTION

In contrast, the fuel injector according to the exemplary embodiment of the present invention may have the advantage that, due to a valve needle that is hollow at least in the spray-discharge section and which is sealed from the combustion chamber on the front end, a high-quality jet pattern and high flow-rate accuracy may be achieved for any preselectable jet pattern.

The valve needle may have a guide region in the nozzle body, which has approximately the same dimensions as the recess of the valve needle. Inflow orifices and metering bores are arranged in the valve needle on the inflow and discharge side of the guide region.

The inflow orifices are advantageously larger than the metering bores so as to avoid throttling effects.

Furthermore, it may be advantageous that the recess in the valve needle is easy to produce by drilling or that the valve needle may also have a hollow design across its entire length.

A hollow, tubular extension of a valve-needle shaft is advantageous, too, since the production, the connection and the introduction of the bores may be carried out in an uncomplicated and cost-effective manner.

A closure member for the front-end sealing of the valve needle may advantageously be designed in many different ways. For instance, it may be lathe-cut or deep-drawn or also be integrally formed with the tube.

### BRIEF DESCRIPTION OF THE DRAWINGS

FIG. 1A shows a schematic section through a first exemplary embodiment of a fuel injector configured according to the present invention, in an overall view.

FIG. 1B shows a schematic cutaway portion from the first exemplary embodiment of a fuel injector according to the present invention shown in FIG. 1A, in region IB of FIG. 1A.

FIG. 2 shows a schematic section through a second exemplary embodiment of a fuel injector configured according to the present invention, in the same illustration as FIG. 1B.

FIG. 3 shows a schematic section through a third exemplary embodiment of a fuel injector configured according to the present invention, in the same illustration as FIG. 1B.

FIG. 4 shows a schematic section through a fourth exemplary embodiment of a fuel injector configured according to the present invention, in the same illustration as FIG. 1B.

FIG. 5 shows a schematic section through a fifth exemplary embodiment of a fuel injector configured according to the present invention, in the same illustration as FIG. 1B.

FIG. 6 shows a schematic section through a sixth exemplary embodiment of a fuel injector configured according to the present invention, in the same illustration as FIG. 1B.

### DETAILED DESCRIPTION

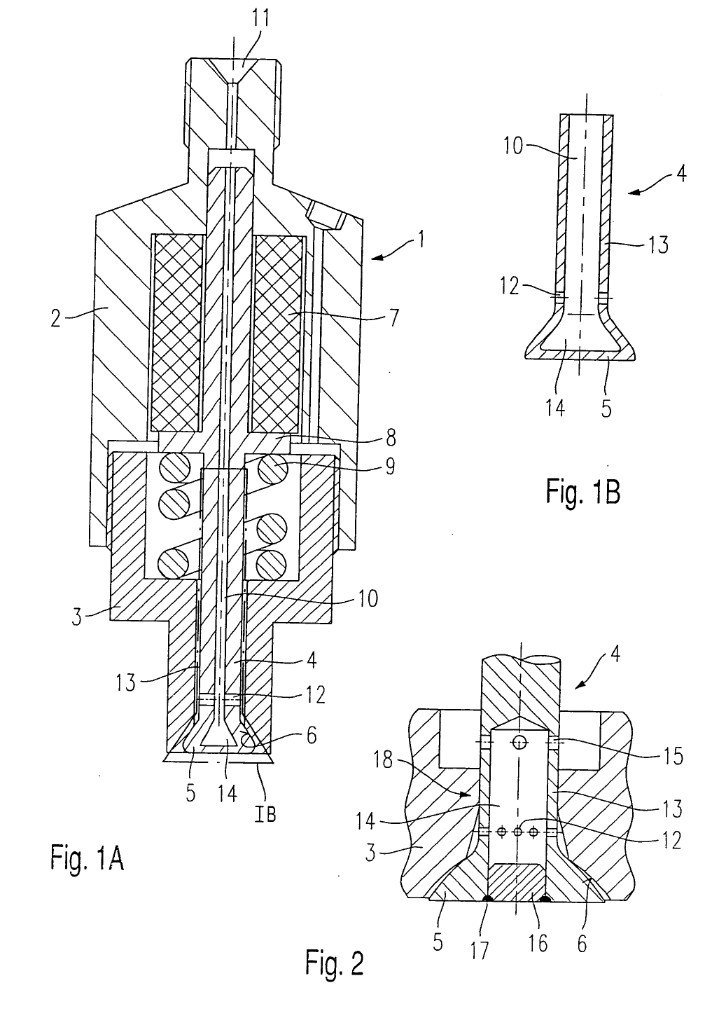

A first exemplary embodiment of a fuel injector 1 according to the exemplary embodiment of the present invention, which is shown in FIG. 1A in an overall view, is configured in the form of a fuel injector 1 for fuel-injection systems of mixture-compressing internal combustion engines having externally supplied ignition. Fuel injector 1 is suited in particular for the direct injection of fuel into a combustion chamber (not shown) of an internal combustion engine.

Fuel injector 1 includes a housing body 2 and a nozzle body 3, in which a valve needle 4 is positioned. Valve needle 4 is in operative connection to a valve closure member 5, which cooperates with a valve seat surface 6 to form a sealing seat. The fuel injector in the exemplary embodiment is an outwardly opening fuel injector 1. It includes an actuator 7, which is embodied as a piezoelectric actuator 7 in the exemplary embodiment. On one side, the actuator is supported at housing body 2 and on the other side at a shoulder 8, which is mechanically linked to valve needle 4. Downstream from shoulder 8 is a restoring spring 9, which in turn is braced on nozzle body 3.

In the rest state of fuel injector 1, shoulder 8 is acted upon by the force of restoring spring 9 counter to the lift direction, in such a way that valve closure member 5 is held in sealing contact on valve seat surface 6. In response to piezoelectric actuator 7 being energized, it expands in the axial direction, counter to the spring force of restoring spring 9, so that shoulder 8 with valve needle 4, which is joined to shoulder 8 by force-locking, is moved in the lift direction. Valve closure member 5 lifts off from valve-seat surface 6, and the fuel conveyed via a central fuel channel 10 and metering bores 12 in valve needle 4 is spray-discharged.

When piezoelectric actuator 7 is discharged, its axial extension is reduced, so that valve needle 4 is moved counter to the lift direction by the pressure of restoring spring 9. Valve closure member 5 sets down on valve seat surface 6 and fuel injector 1 is closed.

According to the exemplary embodiment of the present invention, valve needle 4 has a hollow design, at least in a discharge-side end, and in addition to central fuel channel 10 is provided with metering bores 12 in a wall 13 of the valve needle 4 through which the fuel, conveyed via a central fuel supply 11 on the inflow-side, is guided to the sealing seat. A cavity 14 in valve closure member 5 is sealed from the combustion chamber of the internal combustion engine on the front-side. Valve needle 4 with valve closure member 5 is shown enlarged in FIG. 1B and described in greater detail in the associated description.

Advantages of the fuel supply to the sealing seat through an at least partially hollow valve needle 4 and through metering bores 12 are the more accurate needle guidance, which is imprecise in conventional valve needles due to the beveled surfaces that are required to convey the fuel to the sealing seat; an improvement in the jet quality, in particular reduced skeining, as well as the possibility of selectively forming the jet pattern via the shape and arrangement of metering bores 12 and to improve the flow-rate accuracy as a result of the simple reproducibility of the diameters of metering bores 12.

In a part-sectional representation, FIG. 1B shows the downstream-side end of valve needle 4 of fuel injector 1 illustrated in FIG. 1A. As already mentioned in the description in connection with FIG. 1A, valve needle 4 has a hollow design. Valve closure member 5 is integrally formed with valve needle 4. Such a valve needle 4 may be produced in a particularly simple manner by hydraulic reforming, for example.

Metering bores 12 may be symmetrically arranged across the circumference of valve needle 4 or also be distributed asymmetrically in a selective manner so as to obtain a desired jet pattern. For example, areas may be selectively suppressed, for the purpose of not directly exposing the spark plug to the spray, for instance. The shape of metering bores 12 is not restricted either. Conceivable are longitudinal holes, elliptical or irregularly shaped cross-sections so as to be able to meet various demands on the jet pattern. Metering bores 12 may be introduced in wall 13 of valve needle 4 by drilling, eroding, electrochemical processing or laser drilling. If a multitude of metering orifices 12 is present, all metering orifices 12, with the exception of one, may be implemented without high demands regarding accuracy. Following a flow-rate measurement, final metering orifice 12 may then be introduced using a diameter that will allow a setpoint flow rate.

FIG. 2 shows a second exemplary embodiment of a valve needle 4 configured according to the present invention, in the same cutaway portion as FIG. 1B.

Valve needle 4 is configured as a hollow bore at its downstream end. Inflow orifices 15 are introduced in wall 13 of valve needle 4 on the inflow side of a guide region 18 and convey the fuel into cavity 14. Inflow orifices 15 are larger than metering bores 12 downstream from guide region 18. The shape of inflow orifices 15 is variable as well, as in the case of metering bores 12, and may be selectively adjusted to the particular requirements. The flow orifices may be produced analogously to metering bores 12.

On the front-end, a closure member 16 is inserted into cavity 14 und joined to valve closure member 5 by a welded seam 17, for instance.

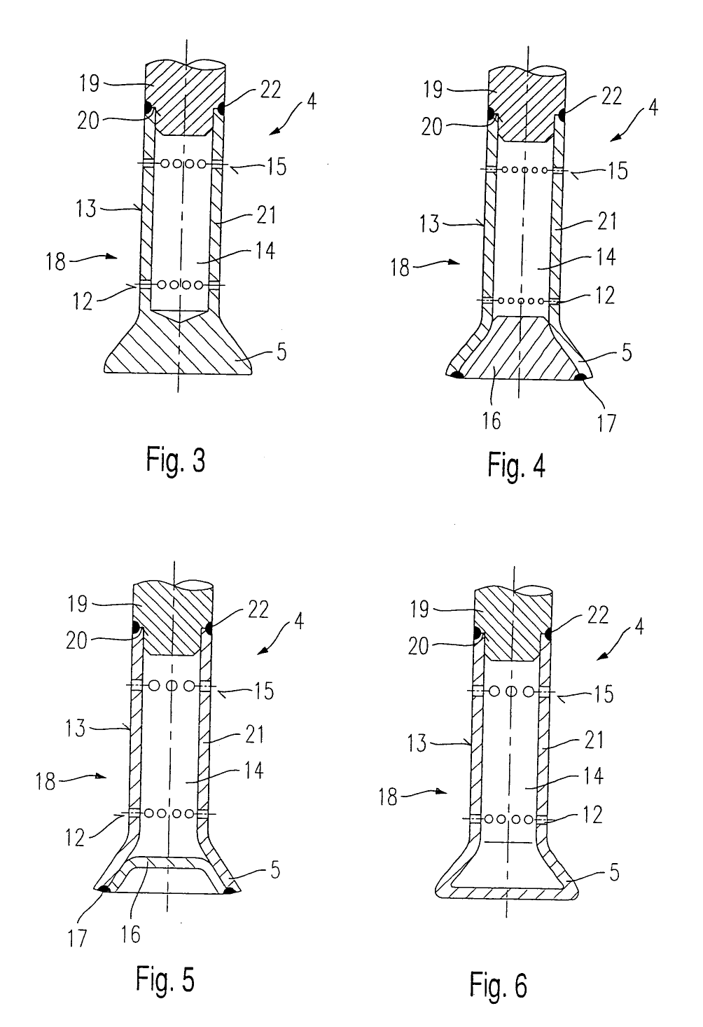

FIG. 3 shows a third exemplary embodiment of a valve needle 4 configured according to the present invention, in the same cutaway portion as FIG. 1B.

As in the exemplary embodiments shown in FIGS. 4 through 6, valve needle 4 has a multipart design. A shaft 19 of valve needle 4 has a shoulder 20 onto which a tube 21 is placed, which carries valve closure member 5 at its downstream-side end. Tube 21 may be joined to shaft 19 by a welded seam 22, for instance. The exemplary embodiment shown may be produced by turning on a lathe and subsequent drilling, for instance.

FIG. 4, in the same cutaway as FIG. 1B, shows a fourth exemplary embodiment of a valve needle 4 configured according to the exemplary embodiment of the present invention. As is the case in exemplary embodiments shown in FIGS. 5 and 6, tube 21 may be made of an easily moldable material such as austenitic sheet metal, which, together with a nozzle body 3 made of martensite, allows a temperature compensation.

In this exemplary embodiment, tube 21 is sealed by a lathe-turned closure member 16 at its front-end and provided with a circumferential row of inflow orifices 15 and metering bores 12. Closure member 16 is joined to tube 21 by a welded seam 17.

FIG. 5, in the same cutaway as FIG. 1B, shows a fifth exemplary embodiment of a valve needle 4 configured according to the exemplary embodiment of the present invention. Tube 21 has a similar shape as in the exemplary embodiment shown in FIG. 4, but closure member 16 is configured as a deep-drawn component. Here, too, a welded seam 17 is provided as connection.

FIG. 6, in the same cutaway as FIG. 1B, shows a sixth exemplary embodiment of a valve needle 4 configured according to the exemplary embodiment of the present invention. In this case, tube 21 is integrally formed with valve closure member 16, similar to valve needle 4 in the first exemplary embodiment shown in FIGS. 1A and 1B, using hydro-reforming or a similar manufacturing method.

The exemplary embodiment of the present invention is not limited to the exemplary embodiment shown, but may also be applied to arbitrary configurations of fuel injectors 1 having any number of actuators 7.

1-17. (canceled)

18. A fuel injector for directly injecting fuel into
a combustion chamber of an internal combustion engine, comprising:
an actuator;
a restoring spring;
a valve closure member;
a valve needle;
a valve seat surface;
a nozzle body;
a valve needle situated in the nozzle body, the valve needle being actuable by the actuator and acted upon by the restoring spring so that the valve closure member, which is in operative connection to the valve needle and faces the combustion chamber, is kept in sealing contact on the valve seat surface in a non-actuated state of the actuator,
wherein the valve needle is hollow at least in a downstream partial region and is sealed off from the combustion chamber at a front-side.

19. The fuel injector of claim 18, wherein the valve needle includes a guide region in which the valve needle is guided.

20. The fuel injector of claim 19, wherein the valve needle includes metering bores downstream from the guide region.

21. The fuel injector of claim 20, wherein the number and arrangement of the metering bores is specified by a jet pattern of fuel jet spray-discharged by the fuel injector.

22. The fuel injector of claim 19, wherein the valve needle includes inflow bores on an inflow side of the guide region.

23. The fuel injector of claim 20, wherein the inflow bores have an overall cross-section that is larger than an overall cross-section of the metering bores.

24. The fuel injector of claim 18, wherein the valve needle is a one-piece, hydro-reformed valve needle.

25. The fuel injector of claim 18, wherein the valve needle is hollowed out at its downstream-side end using drilling.

26. The fuel injector of claim 25, wherein the valve needle includes a two-piece valve needle.

27. The fuel injector of claim 26, wherein the valve needle includes a shaft and a tube.

28. The fuel injector of claim 27, wherein the tube is supported at a shoulder of the shaft.

29. The fuel injector of claim 28, wherein the tube is joined to the shaft by a welded seam.

30. The fuel injector of claim 27, wherein the tube is sealed by a closure member on the front-side.

31. The fuel injector of claim 30, wherein the tube is integrally formed with the closure member.

32. The fuel injector of claim 30, wherein the closure member and the tube are joined by a welded seam.

33. The fuel injector of claim 30, wherein the closure member is produced by turning on a lathe.

34. The fuel injector of claim 30, wherein the closure member is produced by a deep-drawing process.
